(19) United States
(12) Patent Application Publication
(10) Pub. No.: US 2007/0199885 A1
(43) Pub. Date: Aug. 30, 2007

(54) Method for cleaning a filtering system and a filtering system having cleaning capabilities

(76) Inventors: Gil Shmuel, Kefar-Sava (IL); Joshua Belogorodsky, Tel Aviv (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/273,669

(22) Filed: Nov. 14, 2005

(51) Int. Cl. B01D 21/24

(52) U.S. Cl. 210/427

(57) ABSTRACT

A filtering system that includes a filter housing that includes a fluid inlet and a fluid outlet, a substantially cylindrical filter located within the filter housing, and a backwash body movably mounted within the filter housing for backwashing the substantially cylindrical filter. The backwash body includes at least one nozzle adapted to move towards the substantially cylindrical filter during a backwash operation. A method for cleaning a filtering system, the method includes: (i) determining to perform a backwash operation; (ii) helically moving a backwash body that is movably mounted within a filter housing such as to scan an inner face of a substantially cylindrical filter, during the backwash operation; and (iii) moving at least one nozzle towards the inner face of the substantially cylindrical filter, during the backwash operation.

### FIELD OF THE INVENTION

The present invention relates to methods for cleaning a filtering system and to filtering systems having cleaning capabilities.

### BACKGROUND OF THE INVENTION

Filtering systems are used in various fields such as but not limited to filtration of fluids, irrigation water, recycling of sewage and industrial waste water, recycling of cooling towers water, filtration and purification of drinking water etc.

Typical filtering systems include a coarse filter and a fine filter. One inevitable problem of many existing filtering systems is the accumulation of sediments on the filters and especially of the fine filter, blocking it and lowering the flow rate until totally preventing it. Thus, plain filtration systems have to be treated occasionally by cleaning the used blocked filtering element or by replacing it with a clean one, which means interrupting and stopping the filtration process from time to time.

Self-cleaning filtering systems are known in the art. Self-cleaning filtering systems usually clean a cylindrically shaped fine filter by scanning it by a backwash body. The following patents and patent applications, all being incorporated herein by reference, illustrates some prior art self-cleaning filters: U.S. Pat. No. 6,283,305 of Madea et al., titled “Filter apparatus with backwashing mechanism”; U.S. Pat. No. 6,419,823 of DeLonge et al. titled “Apparatus and method for sanitizing and cleaning a filter system”; U.S. Pat. No. 4,295,963 of Drori titled “Backwashable fluid filter”; and U.S. Pat. No. 6,267,879 of Gil. During a backwash operation a pressure difference is introduced between a backwash outlet and the filter that is being cleaned.

A typical backwash body includes multiple nozzles that are fixed to the backwash body and are relatively distant from the cylindrically shaped filter, so that (a) dirt (that can include relatively large particles) that is located between the nozzle and the inner part of the filter, (b) filter deformations, or (c) filter inaccuracies will not slow down the movement of the backwash body, or even stop the movement of the backwash body. In addition, this distance also prevents excess friction between the nozzle and the filter.

This distance reduces the efficiency of the backwash operation.

There is a need to provide efficient and improved methods for cleaning a filtering system and filtering systems having self-cleaning capabilities.

### SUMMARY OF THE INVENTION

According to an embodiment of the invention a filtering system is provided. The filtering system includes a filter housing that includes a fluid inlet and a fluid outlet; a substantially cylindrical filter located within the filter housing; a backwash body movably mounted within the filter housing for backwashing the substantially cylindrical filter; and at least one nozzle in connection with the backwash body, whereas the at least one nozzle is adapted to move towards the substantially cylindrical filter during a backwash operation.

Conveniently, the at least one nozzle is adapted to contact, during the backwash operation, at least one of the following elements: (i) an inner face of the substantially cylindrical filter, or (ii) dirt that is positioned between the inner face of the substantially cylindrical filter and the nozzle.

According to an embodiment of the invention the at least one nozzle can loosely contact either one of elements (i) or (ii).

According to an embodiment of the invention the at least one nozzle is adapted to be positioned in proximity to at least one of elements (i) and (ii).

Conveniently, the nozzle is shaped such that fluid within the filter housing forces the nozzle to move towards the substantially cylindrical filter during the backwash operation.

Conveniently, an outer edge of the nozzle faces an inner face of the substantially cylindrical filter. The area of the outer edge is smaller than an area of a inner edge of the nozzle.

Conveniently, the at least one nozzle is shaped such that the fluid within the filter housing forces the nozzle to contact, or loosely contact, during the backwash operation, at least one of elements (i) and (ii).

According to an embodiment of the invention the backwash body further includes a spring that forces a corresponding nozzle to move towards the substantially cylindrical filter. Conveniently the spring can force the corresponding nozzle to contact, to loosely contact at least one of elements (i) and (ii).

According to an embodiment of the invention the filtering system includes at least one nozzle-limiting element for limiting a movement of at least one corresponding nozzle.

According to an embodiment of the invention the backwash body includes at least one hollow guide and at least one nozzle is adapted to move along a corresponding hollow guide.

According to an embodiment of the invention a method for cleaning a filtering system is provided. The method includes: determining to perform a backwash operation; helically moving a backwash body that is movably mounted within a filter housing such as to scan an inner face of a substantially cylindrical filter, during the backwash operation; and moving at least one nozzle towards the inner face of the substantially cylindrical filter, during the backwash operation.

Conveniently, the method includes moving the at least one nozzle until it contacts or loosely contacts at least one of elements (i) or (ii).

Conveniently, the method includes moving the at least one nozzle until it is positioned at a small distance from at least one of elements (i) or (ii).

According to an embodiment of the invention the moving includes moving the at least one nozzle by the fluid within the filter housing.

Conveniently, the method comprises maintaining the at least one nozzle in proximity to at least one of elements (i) and (ii) by the fluid the flows through the filtering system, during the backwash operation.

Conveniently, the fluid that flows during the backwash operation can cause the at least one nozzle to contact (or maintain in contact with) at least one of elements (i) and (ii). Said contact can be a loose contact.

Conveniently, the method includes moving the at least one nozzle by at least one corresponding spring.

### BRIEF DESCRIPTION OF THE FIGURE

The present invention will be understood and appreciated more fully from the following detailed description taken in conjunction with the drawings in which:

FIG. 1 is a cross sectional view of a filtering system, according to an embodiment of the invention;

FIG. 2 is a cross sectional view of a filtering system, according to another embodiment of the invention;

FIG. 3 is a cross sectional view of a backwash body, according to an embodiment of the invention;

FIG. 4 is a cross sectional view of a guide and a nozzle, according to an embodiment of the invention;

FIG. 6 is a cross sectional view of a guide and a nozzle, according to another embodiment of the invention;

FIG. 7 is a cross sectional view of a guide and a nozzle, according to a further embodiment of the invention; and

FIG. 8 is a flow chart illustrating a method for cleaning a filtering system, according to an embodiment of the invention.

### DETAILED DESCRIPTION OF THE FIGURE

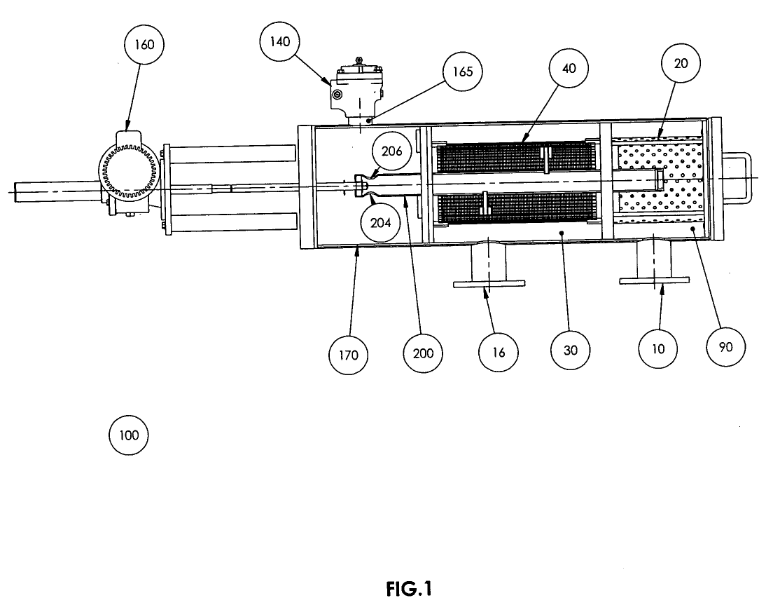

FIG. 1 is a cross sectional view of filtering system 100, according to an embodiment of the invention. The cross section is made along an imaginary longitudinal axis of the filtering system.

Filtering system 100 can include one or more filters. It usually includes a coarse filter as well as a fine filter. For simplicity of explanation it is assumed that filtering system 100 includes a cylindrical coarse filter 20 and a substantially cylindrical filter 40 that is also refereed to as fine filter 40.

It is noted that the coarse filter 20 can be subjected to a backwash operation, but this is not necessarily so. For convenience of explanation the following description refers to backwash operation of fine filter 40.

Filtering system 100 includes an elongated tube shaped housing 170 having fluid inlet 10 for a connection with a fluid supply duct (not illustrated), through which the fluid enters a preliminary filtering chamber 90. The preliminary filtering chamber 90 is opened to a final filtering chamber 30 through the coarse filter 20 that is adapted to removing rough particles from the fluid.

The pre-filtered fluid which passes the coarse filter 20 flows through the fine filter 40 to the filtered fluid chamber 30 and to the fluid outlet 160 adapted for a connection with a filtered fluid duct (not illustrated). Conveniently, the preliminary filtering chamber 90 and the filtered fluid chamber 30 are two compartments within one tube shaped envelope.

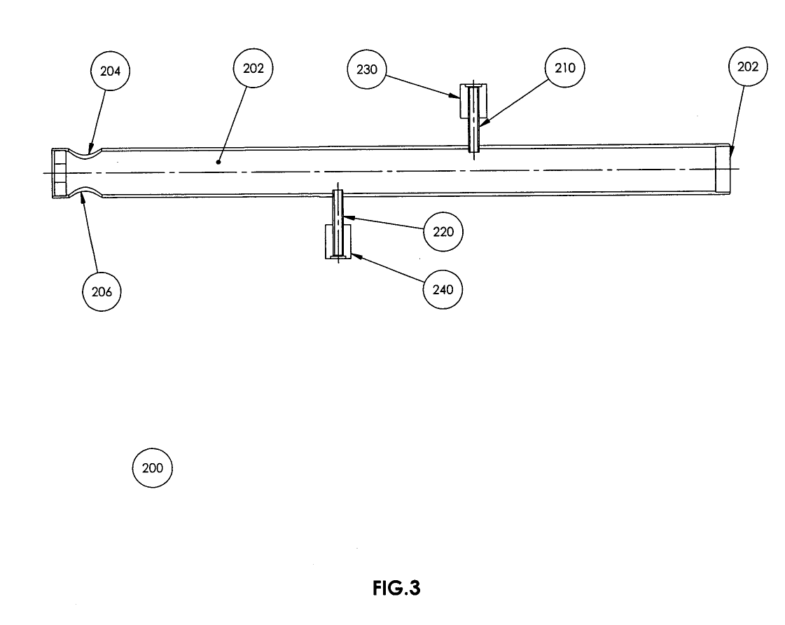

A backwash body 200 is movably mounted within the filter housing 170. The backwash body 200 includes an elongated hollow portion 202 (of FIG. 3), and at least one hollow guide, such as guides 210 and 220 (of FIG. 3), that extend from the hollow portion 202 towards the fine filter 40. The backwash body 200 is in contact with at least one nozzle, such as nozzles 230 and 240 (of FIG. 3) that can move, conveniently along guides 210 and 220, towards the inner face of the fine filter 40 during a backwash operation. The elongated hollow portion 202 includes one or more outlets, such as outlets 204 and 206 (of FIG. 3) that are located within the filtered fluid chamber 30.

While the backwash body 200 and especially the elongated hollow portion 202 performs a helical movement within the filter housing 170, the nozzle 230 further move towards the inner face of fine filter 40 such as to increase the efficiency of the backwash operation.

Thus, while the backwash body 200 moves along an imaginary longitudinal axis of the filtering system 100 and also rotates (performs a tangential movement) about that imaginary longitudinal axis, the nozzles further perform a radial movement towards the inner face of fine filter 40.

The backwash operation is usually activated according to a differential pressure sensor gauge that is adapted for identifying a predetermined differential pressure between different portions of the filtering system, indicating that a certain amount of dirt blocks the filter, thus a cleaning operation is required. The backwash operation can be initiated, additionally or alternatively, in a periodic manner, in a random manner, in a quasi-random manner, automatically, manually, in response to a request to perform such as backwash operation, and the like.

The helical movement can be induced by a motor, by hydraulic mechanisms, automatically or manually, and the like.

FIG. 1 illustrates filtering system 100 that includes an electrical motor 160 that induces the helical movement. Such motors as well as driving mechanisms are known in the art and some are illustrated by the patents that were mentioned above. In general, the driving mechanism translates the rotation of the motor to a helical movement of the backwash body 200. The direction (clockwise or counterclockwise) of the rotation of the backwash body is dictated by the rotation direction of the motor 160. The motor 160 can be activated in various manners. The direction of the rotation can be switched according to the location of the backwash body 200, in response to the number of rotations and/or in response to rotation periods.

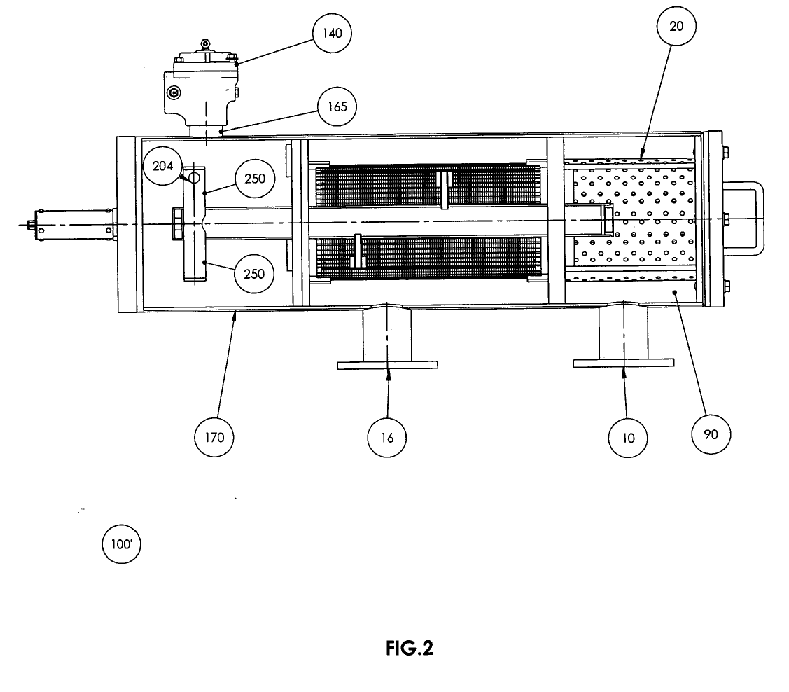

FIG. 2 is a cross sectional view of filtering system 100′, according to an embodiment of the invention.

Filtering system 100′ does not include a motor 160 but includes a backwash body 200 that includes two relatively large hollow guides 250 that are shaped so that the propagation of fluid within the filtered fluid chamber 30 (towards the backwash valve 140) rotates the fins. This rotation is then translated to a helical movement. These guides can also be referred to as jets or as an hydraulic motor.

The nozzles 230 and 240 are hollow such as to allow fluid, dirt and particles to propagate towards the backwash body 200.

The guides 210 and 220 and accordingly the nozzles 230 and 240 are usually spaced apart from each other. It is further noted that the amount of guides can differ then two. Conveniently, the different guides are positioned such that during the helical movement of the backwash body 200 substantially the entire fine filter 40 is backwashed.

During the backwash operation fluid, dirt and particles are sucked into the nozzles 230 and 240, pass through the backwash guides 210 and 220, the backwash body 200, the filtered fluid chamber 30, the backwash outlet 165 and the opened backwash valve 140.

Conveniently, the suction operation is generated automatically by the pressure-difference between the pressure of the fluid within the filter housing 170 and the pressure of the free atmosphere to which the backwash valve 140 is opened during the backwash operation.

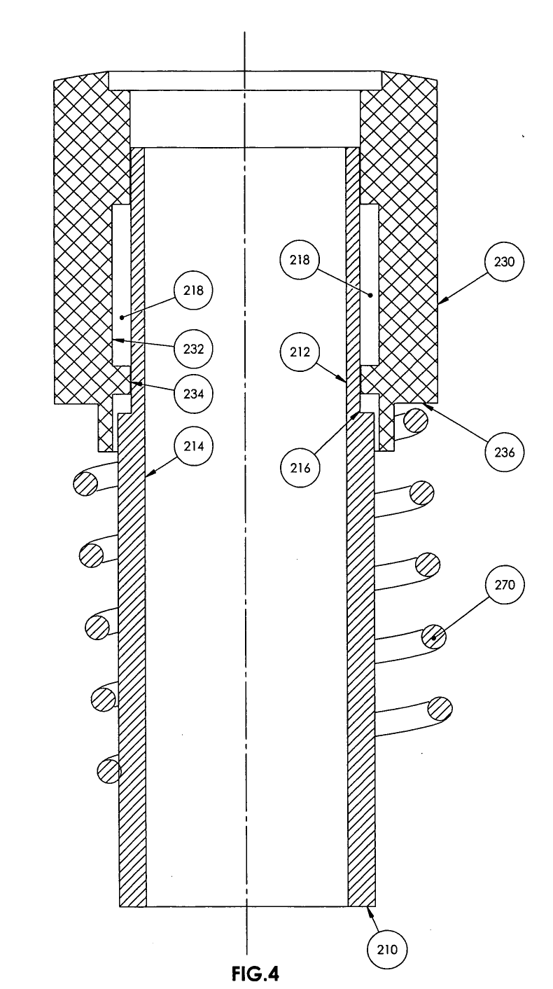

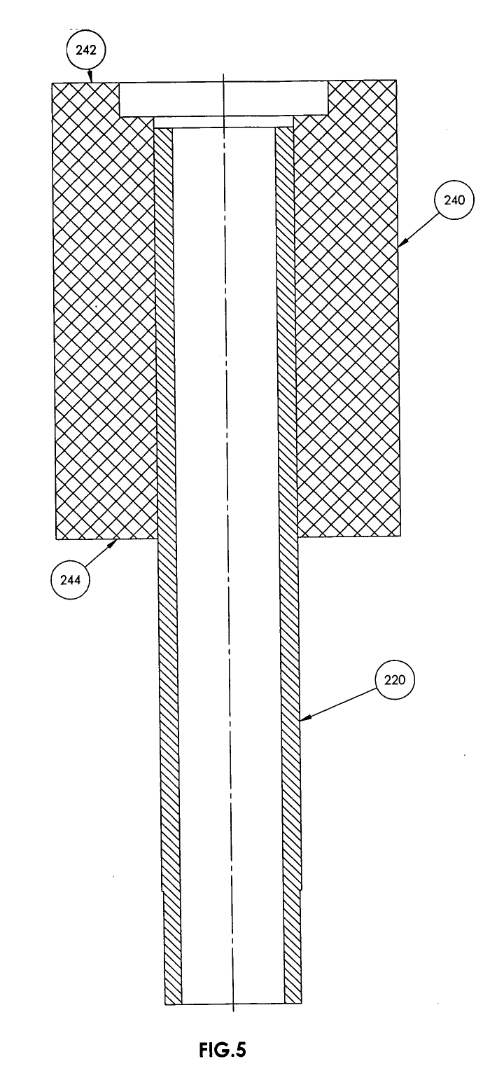

FIG. 4 is a cross sectional view of guide 210 and nozzle 230, according to an embodiment of the invention.

Guide 210 has a cylindrical shape. FIG. 4 illustrates a guide 210 that includes an upper portion 212 and a lower portion 214. The upper portion 212 is thinner than the lower portion 214 such as to define a step 216 that limits the radial movement of nozzle 230 towards the elongated hollow portion 202.

The nozzle 230 can move along an imaginary radial axis that is substantially perpendicular to the imaginary longitudinal axis of the filtering system 100.

Conveniently, nozzle 230 moves along guide 210, or at least along upper portion 212, while extending towards the inner part of fine filter 40.

Nozzles 230 can have a cylindrical shape. It is conveniently shaped such as to define an annular space 218 between a portion 232 of the inner face of nozzle 230 and the outer face of guide 210. Another portion 234 of the inner face of nozzle 230 contacts the outer face of guide 210, thus allowing nozzle 230 to move along guide 210. The annular space 218 reduces the friction between nozzle 230 and guide 210. It is noted that other shapes (of the nozzle, guides and space) can be used without departing from the spirit of the invention.

A spring 270 placed on the lower portion 214 of guide 210. The spring 270 contacts a inner edge 236 of nozzle 230 and forces the nozzle 230 to move towards the inner face of fine filter 40. The lower end 236 of nozzle can include an annular recess or annular step that are shaped such as to contact one end of the spring 270. The lower end 236 of nozzle 230 can also include a step of a recess that is shaped according to step 216 of guide 210.

If fine filter 40 was totally clean and was ideally cylindrical then the distance between the fine filter and the elongated hollow portion 202 is maintained fixed. In reality the distance can change due to filter deformations, filter manufacturing inaccuracies, and filter (or backwash body) misalignment. In addition, dirt can be stuck between the nozzle and the fine filter 40. In over to provide efficient cleaning in these conditions the distance between the nozzle end and an imaginary longitudinal axis of the filtering system can be adjusted in various manners. FIG. 4 illustrates a spring 270 that cause the nozzle 230 to track a pattern defined by the inner face of the fine filter 40, and optionally by dirt that is positioned between the nozzle and the inner face of the fine filter 40.

According to an embodiment of the invention the nozzle can be shaped such that the fluid within the filter housing forces the nozzle to substantially contact the inner face of fine filter 40 during the backwash operation.

Conveniently, the centrifugal force and/or gravity (when the nozzle is below hollow elongated portion 202) force the nozzle to move towards the inner face of fine filter 40. Once the nozzle is proximate to the inner face of the fine filter 40 the fluid forces the nozzle to maintain in proximity to the inner face of the fine filter 40 (or near dirt positioned between the nozzle 230 and the inner face of the fine filter 40).

FIG. 5 is a cross sectional view of a guide 220 and a nozzle 240, according to another embodiment of the invention.

Nozzle 240 includes an outer edge 242 and an inner edge 244. The outer edge 242 faces an inner face of fine filter 40. The area of the outer edge 242 is smaller than the area of the inner edge 244.

During the backwash operation fluid flows through the final filtering chamber 30 toward the space defined within nozzle 240. Due to this flow the outer edge 242 of nozzle 240 is pushed away from the fine filter 40 while the inner edge is pushed towards the fine filter. Because the area of the inner edge 244 is larger than the area of the outer edge 242 of nozzle 240 the overall effect of the fluid flow is to push nozzle 240 towards the inner face of fine filter 40.

Conveniently, an upper portion of nozzle that is defined by the outer edge 242 is thinner that a lower portion of the nozzle as defined by the inner edge 244 of nozzle 240. This can be achieved in various manners such as but not limited by defining an annular recess 246 within outer edge 244.

It is noted that the outer edge 244 can be shaped in various manners. The shape of outer edge 244 may correspond to the shape of fine filter 40. It can be curved, include multiple angled surfaces and the like.

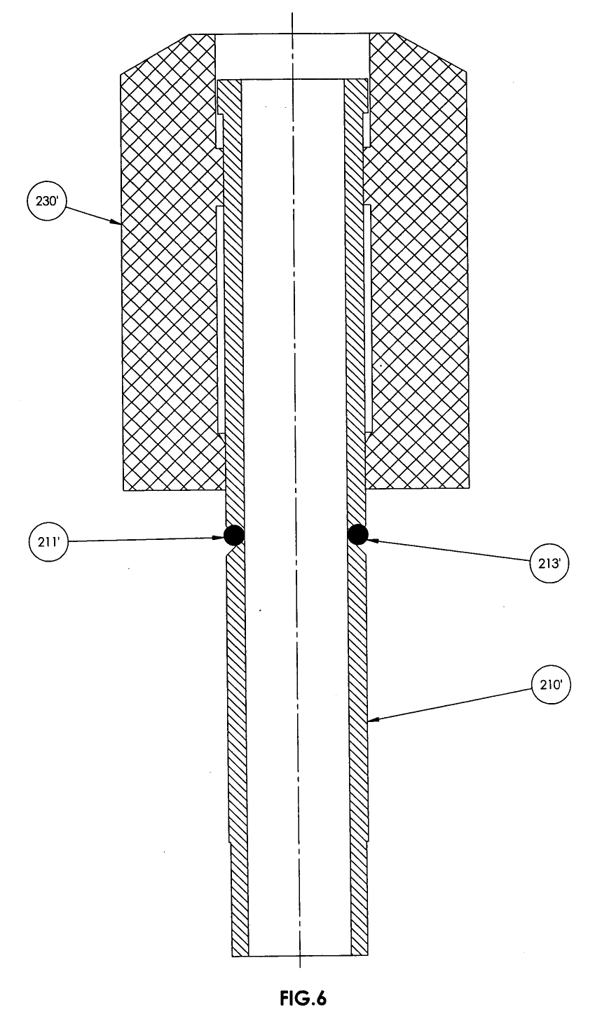

FIG. 6 is a cross sectional view of a guide 210′ and a nozzle 230′, according to a further embodiment of the invention.

Guide 210′ includes an annular recess 211′ and a ring 213′ that is partially located within the annular recess 211′. The ring 213′ limits the movement of nozzle 230′ towards the elongated hollow portion 202.

Nozzle 230′ is shaped such that during the backwash operation the fluid that flows towards the backwash outlet forces it to maintain in proximity to the inner face of the fine filter 40 (or near dirt positioned between the nozzle 230′ and the inner face of the fine filter 40).

The inner face of nozzle 230′ is also shaped such as to define two annular spaces between the inner face of nozzle 230′ and the outer face of guide 210′.

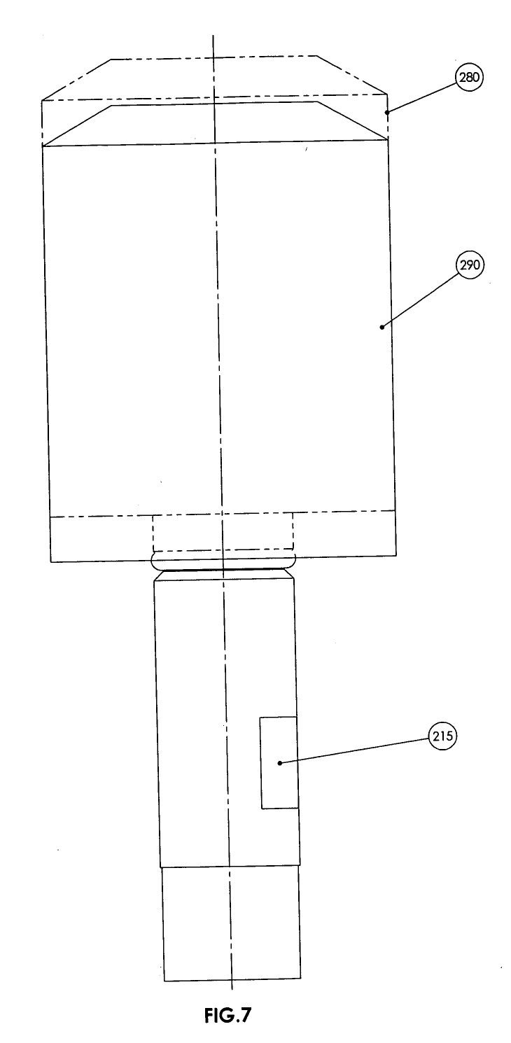

FIG. 7 illustrates two possible positions of a nozzle, according to an embodiment of the invention.

Nozzle 230 can move between two positions—an upper position 280 (closer to the inner face of fine filter 40) and a lower position 290 (closer to the elongated hollow portion 202). The dashed curves illustrated the upper position 280.

The guide 210 is illustrated as having a recess 215 for easing the fastening of the guide 210.

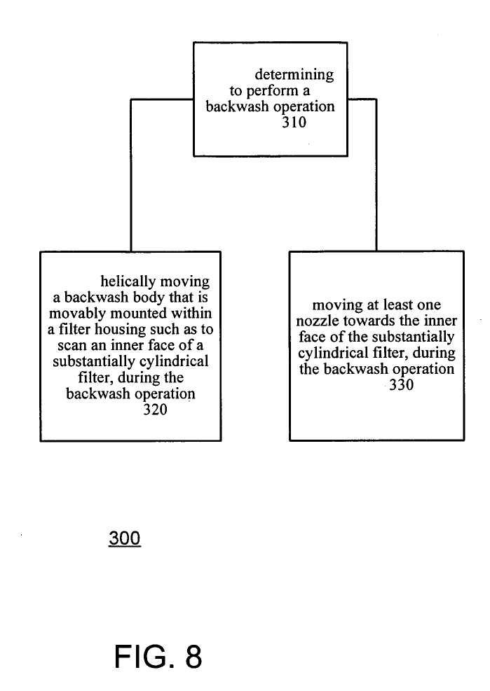

FIG. 8 is a flow chart illustrating method 300 for cleaning a filtering system, according to an embodiment of the invention.

Method 300 starts by stage 310 of determining to perform a backwash operation.

Stage 310 is followed by stages 320 and 330. Stage 320 includes helically moving a backwash body that is movably mounted within a filter housing such as to scan an inner face of a substantially cylindrical filter, during the backwash operation.

Stage 330 includes moving at least one nozzle towards the inner face of the substantially cylindrical filter, during the backwash operation.

Stages 320 and 330 can be continued until the backwash operation terminates. Conveniently once the backwash operation terminates a filtering process initiates.

Conveniently, stage 330 includes moving the at least one nozzle until it contacts at least one of the following: (i) an inner face of the substantially cylindrical filter, and (ii) dirt that is positioned between the inner face of the substantially cylindrical filter and the nozzle.

Conveniently, stage 330 includes moving the at least one nozzle until it loosely contacts an inner face of the substantially cylindrical filter or dirt that is positioned between the inner face of the substantially cylindrical filter and the nozzle.

Conveniently, stage 330 includes moving the at least one nozzle until it is positioned at a small distance from at least one of the following: (i) an inner face of the substantially cylindrical filter, and (ii) dirt that is positioned between the inner face of the substantially cylindrical filter and the nozzle.

Conveniently, stage 330 includes moving the at least one nozzle by the fluid within the filter housing.

According to an embodiment of the invention stage 330 can include maintaining, by the fluid that flows during the backwash operation, the at least one nozzle in proximity to the inner face of the substantially cylindrical filter.

Conveniently the fluid can cause the at least one nozzle to contact (and even loosely contact) the inner face of the substantially cylindrical filter or dirt that is positioned between the inner face of the substantially cylindrical filter and the nozzle.

Conveniently, stage 330 involves moving the at least one nozzle by a spring.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A filtering system comprising:
a filter housing comprising a fluid inlet, a fluid outlet and a backwash outlet;
a substantially cylindrical filter located within the filter housing;
a backwash body movably mounted within the filter housing for backwashing the substantially cylindrical filter; and
at least one nozzle in connection with the backwash body, whereas the at least one nozzle is adapted to move towards the substantially cylindrical filter during a backwash operation.

2. The filtering system according to claim 1 whereas the at least one nozzle is adapted to contact, during the backwash operation, at least one of the following: (i) an inner face of the substantially cylindrical filter, and (ii) dirt that is positioned between the inner face of the substantially cylindrical filter and the nozzle.

3. The filtering system according to claim 1 whereas the at least one nozzle is adapted to loosely contact, during the backwash operation, at least one of the following: (i) an inner face of the substantially cylindrical filter, and (ii) dirt that is positioned between the inner face of the substantially cylindrical filter and the nozzle.

4. The filtering system according to claim 1 whereas the at least one nozzle is adapted to be positioned in proximity to at least one of the following: (i) an inner face of the substantially cylindrical filter, and (ii) dirt that is positioned between the inner face of the substantially cylindrical filter and the nozzle.

5. The filtering system according to claim 1 wherein the at least one nozzle is shaped such that fluid within the filter housing forces the nozzle to move towards the substantially cylindrical filter during the backwash operation.

6. The filtering system according to claim 1 whereas an outer edge of the nozzle faces an inner face of the substantially cylindrical filter and whereas an area of the outer edge is smaller than an area of a inner edge of the nozzle.

7. The filtering system according to claim 1 wherein the at least one nozzle is shaped such that the fluid within the filter housing forces the nozzle to contact, during the backwash operation, at least one of the following: (i) an inner face of the substantially cylindrical filter, and (ii) dirt that is positioned between the inner face of the substantially cylindrical filter and the nozzle.

8. The filtering system according to claim 1 whereas the backwash body further comprises a spring that forces a corresponding nozzle to move towards the substantially cylindrical filter.

9. The filtering system according to claim 1 further whereas a backwash body further comprises a spring that forces a corresponding nozzle to contact, during the backwash operation, at least one of the following: (i) an inner face of the substantially cylindrical filter, and (ii) dirt that is positioned between the inner face of the substantially cylindrical filter and the nozzle.

10. The filtering system according to claim 1 further comprising at least one nozzle limiting element for limiting a movement of at least one corresponding nozzle.

11. The filtering system according to claim 1 whereas the backwash body comprises at least one hollow guide and whereas at least one nozzle is adapted to move along a corresponding hollow guide.

12. A method for cleaning a filtering system, the method comprising:
determining to perform a backwash operation;
helically moving a backwash body that is movably mounted within a filter housing such as to scan an inner face of a substantially cylindrical filter, during the backwash operation; and
moving at least one nozzle towards the inner face of the substantially cylindrical filter, during the backwash operation.

13. The method according to claim 12 whereas the moving comprises moving the at least one nozzle until it contacts at least one of the following: (i) an inner face of the substantially cylindrical filter, and (ii) dirt that is positioned between the inner face of the substantially cylindrical filter and the nozzle.

14. The method according to claim 12 whereas the moving comprises moving the at least one radial backwash element until it loosely contacts at least one of the following: (i) an inner face of the substantially cylindrical filter, and (ii) dirt that is positioned between the inner face of the substantially cylindrical filter and the nozzle.

15. The method according to claim 12 whereas the moving comprises moving the at least one nozzle until it is positioned at a small distance from at least one of the following: (i) an inner face of the substantially cylindrical filter, and (ii) dirt that is positioned between the inner face of the substantially cylindrical filter and the nozzle.

16. The method according to claim 12 whereas the moving comprising moving the at least one nozzle by the fluid within the filter housing.

17. The method according to claim 16 whereas the moving comprises moving the at least one nozzle until it contacts at least one of the following: (i) an inner face of the substantially cylindrical filter, and (ii) dirt that is positioned between the inner face of the substantially cylindrical filter and the nozzle.

18. The method according to claim 12 whereas the moving comprising moving the at least one nozzle by at least one corresponding spring.

19. The method according to claim 18 whereas the moving comprises moving the at least one nozzle until it contacts at least one of the following: (i) an inner face of the substantially cylindrical filter, and (ii) dirt that is positioned between the inner face of the substantially cylindrical filter and the nozzle.

20. The method according to claim 12 comprising maintaining, during the backwash operation, the at least one nozzle in proximity to at least one of the following: (i) an inner face of the substantially cylindrical filter, and (ii) dirt that is positioned between the inner face of the substantially cylindrical filter and the nozzle

21. The method according to claim 12 comprising maintaining, by fluid that flows during the backwash operation, the at least one nozzle in proximity to at least one of the following: (i) an inner face of the substantially cylindrical filter, and (ii) dirt that is positioned between the inner face of the substantially cylindrical filter and the nozzle

22. The method according to claim 12 comprising maintaining, by fluid that flows during the backwash operation, the at least one nozzle in proximity to at least one of the following: (i) an inner face of the substantially cylindrical filter, and (ii) dirt that is positioned between the inner face of the substantially cylindrical filter and the nozzle.
